(19) United States
(12) Patent Application Publication
(10) Pub. No.: US 2019/0068694 A1
(43) Pub. Date: Feb. 28, 2019

(54) LOAD BALANCER FOR MULTIPATH-CAPABLE CLIENTS AND SERVERS

(71) Applicant: NEC Laboratories Europe GmbH, Heidelberg (DE)

(72) Inventors: Andreas Ripke, Neckargemuend (DE); Simon Oechsner, Den Haag (NL); Johannes Lessmann, Gummersbach (DE)

(21) Appl. No.: 16/079,106

(22) PCT Filed: Feb. 26, 2016
(86) PCT No.: PCT/EP2016/054141

§ 371 Date: Aug. 23, 2018

(51) Int. Cl. H04L 29/08; H04L 12/26; H04W 28/08; H04L 29/06

(52) U.S. Cl. CPC H04L 67/1002; H04L 69/16; H04W 28/08; H04L 43/04

(57) ABSTRACT

A method for performing load balancing among a plurality of multipath-capable servers being provided behind a load balancer and being configured to process requests from multipath-capable clients includes contacting, by a first multipath-capable client, the load balancer for establishing an initial subflow. The method further includes selecting, by the load balancer from the plurality of multipath-capable servers, a selected server by applying a load balancing algorithm, and forwarding, by the load balancer, packets of the initial subflow to the selected server and not accepting any further subflows from the client. The method further includes announcing, by the selected server, at least one public interface to the client via the initial subflow for establishing any subsequent subflows directly between the client and the selected server.

### CROSS REFERENCE TO RELATED APPLICATIONS

This application is a U.S. National Phase application under 35 U.S.C. § 371 of International Application No. PCT/EP2016/054141, filed on Feb. 26, 2016. The international application was published in English on Aug. 31, 2017 as WO 2017/144123 A1 under PCT Article 21(2)

### FIELD

The present invention relates to a method and a system for performing load balancing among a plurality of multipath-capable servers, wherein said servers are provided behind a load balancer and configured to process requests from multipath-capable clients.

### BACKGROUND

Load balancing or load distribution is a widely used technique in today's client-server pattern, allowing the use of a pool of servers to answer client requests, thus creating a service scalable in the number of clients it can serve. In addition, the server pool can consist of servers with different processing performance, since the load balancing algorithm can take into account the actual capacities of the individual servers when selecting a server to answer the next client request.

Different implementations of load distribution exist and are used in prior art. One is based on DNS resolutions, i.e., the client is already directed to a specific server with the result of the DNS lookup of the service. This approach necessitates a relatively tight coupling between the server management and the authoritative DNS servers hosting the resource records for the service domain. In addition, the TTL (Time-To-Live) values of the resource records sent to clients or resolvers on the clients' behalf need to be short to allow a dynamic selection of server depending on current load conditions. This means that these entries are not supposed to be cached for long (they become stale after seconds), and thus a higher share of resolution requests (implying a longer delay) before clients can access the service.

An alternative popular solution is to use L4 or address rewriting load balancers that act as a public interface towards the clients and that transparently forward connection or service requests from clients to selected servers by rewriting header fields of incoming and outgoing packets. This enables hiding the server interfaces from clients, but causes a higher load on the load balancer since all traffic has to pass through it.

Recently, multipath protocols have risen as an evolution of traditional single-path protocols such as TCP (Transmission Control Protocol), promising a higher reliability, as well as better resource usage and congestion avoidance. Multipath TCP (MPTCP) has been standardized by the IETF (for reference, see Ford et al.: “RFC 6824: TCP Extensions for Multipath Operation with Multiple Addresses”, toolsietforg/html/rfc6824) and is built on multiple TCP subflows, easing adoption since middleboxes recognize TCP and do not drop packets.

However, multipath protocols pose a challenge to load balancing because different subflows belonging to the same end-to-end multipath connection could possibly end up at different servers if the load balancer is not aware of the multipath protocol, leading to incomplete state and no response being sent to the client (as indicated in FIG. 1). The reason for this is that new subflows are established using TCP SYN packets from or to new client/server interfaces or addresses, i.e., addresses previously unknown or unused by the load balancer. While the MPTCP option used for establishing new subflows (MP_JOIN) is different from the option for initial connection establishment (MP_CAPABLE for the first subflow), this information alone does not allow the load balancer to decide to which server already existing subflows had been forwarded. In the worst case, the load balancer could then select a different server for the new subflow than for the existing one.

Since a server receiving a SYN packet for a new subflow needs to have received the first subflow of that MPTCP connection as well, in order to be able to accept it and to continue with the handshake, the establishment of the new subflow fails at that moment.

One type of solution for this problem currently under discussion in the IETF (for reference, see Paasch et al.: “Multipath TCP behind Layer-4 loadbalancers, draft-paasch-mptcp-loadbalancer-00”, MPTCP Working Group, Internet-Draft, Sep. 7, 2015) is to modify the use of tokens for MPTCP subflow establishment in order to let load balancers recognize subflows belonging to the same connection. However, this presupposes additional state or cryptographic operations on the load balancer per multipath connection.

### SUMMARY

In an embodiment, the present invention provides a method for performing load balancing among a plurality of multipath-capable servers being provided behind a load balancer and being configured to process requests from multipath-capable clients. The method includes contacting, by a first multipath-capable client, the load balancer for establishing an initial subflow. The method further includes selecting, by the load balancer from the plurality of multipath-capable servers, a selected server by applying a load balancing algorithm, and forwarding, by the load balancer, packets of the initial subflow to the selected server and not accepting any further subflows from the client. The method further includes announcing, by the selected server, at least one public interface to the client via the initial subflow for establishing any subsequent subflows directly between the client and the selected server.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view illustrating a general problem of multipath-unaware load balancing;

FIG. 2 is a schematic view illustrating a multipath-aware load balancing solution in accordance with an embodiment of the present invention; and

FIG. 3 is a schematic view illustrating a subflow setup between a client, a load balancer and a server, using MPTCP, in accordance with an embodiment of the present invention.

### DETAILED DESCRIPTION

Embodiments of the present invention provide methods and systems for performing load balancing among a plurality of multipath-capable servers in such a way that the above mentioned additional state or load is avoided, while still solving the load balancing issue for multipath connections.

According to embodiments of the invention, methods are provided for performing load balancing among a plurality of multipath-capable servers, wherein said servers are provided behind a load balancer and configured to process requests from multipath-capable clients, the methods comprising: by a multipath-capable client, contacting said load balancer for establishing an initial subflow, by said load balancer, selecting a server selected server from said plurality of servers by applying a load balancing algorithm, forwarding packets of said initial subflow to said selected server, and not accepting any further subflows from said client, and by said selected server, announcing at least one public interface to said client via said initial subflow for establishing any subsequent subflows directly between said client and said selected server.

Furthermore, according to embodiments of the invention, systems are provided comprising a load balancer, and a plurality of multipath-capable servers, wherein said servers are provided behind said load balancer and configured to process requests from multipath-capable clients, wherein said load balancer is configured to receive a request for establishing an initial subflow from a client and to select a server selected server from said plurality of servers for serving said request by applying a load balancing algorithm, to forward packets of said initial subflow to said selected server, and to not accept any further subflows from said client, and wherein said selected server is configured to announce at least one public interface to said client via said initial subflow for establishing any subsequent subflows directly between said client and said selected server.

According to the invention, it has been recognized that load balancing for multipath-capable servers that process requests from multipath-capable clients can be implemented by taking advantage of the flexibility that results from the ability to establish and close subflows while maintaining an end-to-end connection. Specifically, in methods according to embodiments of the present invention, only an initial subflow is established via the load balancer, but all subsequent subflows are established directly between the client and the sever. By doing so, any additional processing demands or state (and depending on the implementation even load) on the load balancer can be avoided, while still solving the load balancing issue for multipath connections. As a result, since methods according to the present invention reduce resources on the load balancer required for holding and processing state minimal, the scalability of this approach is increased in comparison to prior art methods.

To summarize, embodiments of the present invention intelligently exploit multipath protocol (e.g. MPTCP) features in order to minimize state/processing on load balancers by letting the load-balanced servers announce their interfaces for additional direct subflows, without additional signaling beyond normal multipath (e.g. MPTCP) session setup. According to embodiments of the invention, it is important to not accept further subflows from a particular client (i.e. after an initial subflow from that client) at the (first) loadbalancer and that the selected server announces local reachable interfaces to that client via the established initial subflow.

According to embodiments, the load balancer transparently forwards the initial subflow of the client to a server selected according to its load balancing algorithm. The only state the load balancer may keep (in relation to the respective client) are forwarding rules for the packets of this subflow, if the client should be allowed to immediately send traffic to the selected server via the load balancer. In this case, the load balancer will act like a NAT for the packets of this subflow as long as it is active. In particular, it does not need to store any transport connection-specific state apart from port numbers, i.e., no storing of MPTCP tokens as in other approaches.

According to embodiments, user data traffic may be allowed to be sent from the client only after at least one direct subflow with the respective server (i.e. the server selected by the load balancer) has been established, and only via this at least one direct subflow. According to an embodiment this may be implemented by configuring the load balancer to set a receive window of 0 to the client during the initial subflow establishment, thereby minimizing the traffic that needs to be forwarded by the load balancer. The load balancer may be configured to dynamically choose between these options (i.e. allowing or denying traffic exchange prior to the establishment of a first direct client-server subflow) depending on the load balancer's load conditions, managing a trade-off between lower load on the load balancer or shorter delay until the data transfer between the client and the selected server can start.

According to embodiments, it may be provided that the initial subflow is to be used only as a backup path. This prevents packets from being sent over the subflow once a second subflow is established. Again, the load balancer may be configured to decide dynamically on this option.

According to embodiments, once at least one direct client-server subflow is established, traffic may be exchanged exclusively directly between the server and the client and not via the load balancer. It may be provided that the initial subflow is closed once at least one new subflow has been established directly between the server and the client. The corresponding state on the load balancer can be deleted, freeing the occupied resources.

According to embodiments, the load balancer is configured to terminate or reject any requests for establishing a new subflow to an already existing multipath TCP connection. In case of using MPTCP this may be realized by responding to any MP_JOIN SYN packets from a client, which has already established an initial subflow via the load balancer, with a reject message (in particular MPTCP's RST message). Alternatively, it may be provided that the load balancer indicates to the client by means of a dedicated flag that any requests for establishing a new subflow associated to an already existing multipath TCP connection are to be sent to other addresses to be announced by the server.

As already mentioned above, according to embodiments of the invention the selected server negotiates the establishment of further subflows directly with the client. In this regard it should be noted that, since additional subflows generally utilize new interfaces, it does not cause problems in the client stack that these new subflows are established directly with the server instead of the known public interface of the load balancer. In order to protect the server from the security consequences of disclosing its interfaces (e.g., DDoS attacks), the server may be configured to ignore and/or reject subflows that do not match any existing initial subflows that have passed via the load balancer. In other words, the server will only accept subflows matching existing initial subflows that have passed via the load balancer, where the same precautions as in current systems can be taken.

According to embodiments, in addition to or alternative to the above security measures, the server may be configured to select its announced public interfaces by taking into account security considerations. In addition, when the server is controlling which of its interfaces it announces to clients, it can manage the set of addresses to which a specific new client can establish new subflows and during which time. For instance, the server may be configured to vary the announced addresses over time, e.g., by selecting ‘valid’ addresses randomly from a large pool of addresses, and accepting new subflows to these addresses for a short, fixed amount of time only, e.g., 1 minute, avoiding or at least reducing the probability that clients later try to connect to addresses they have seen before.

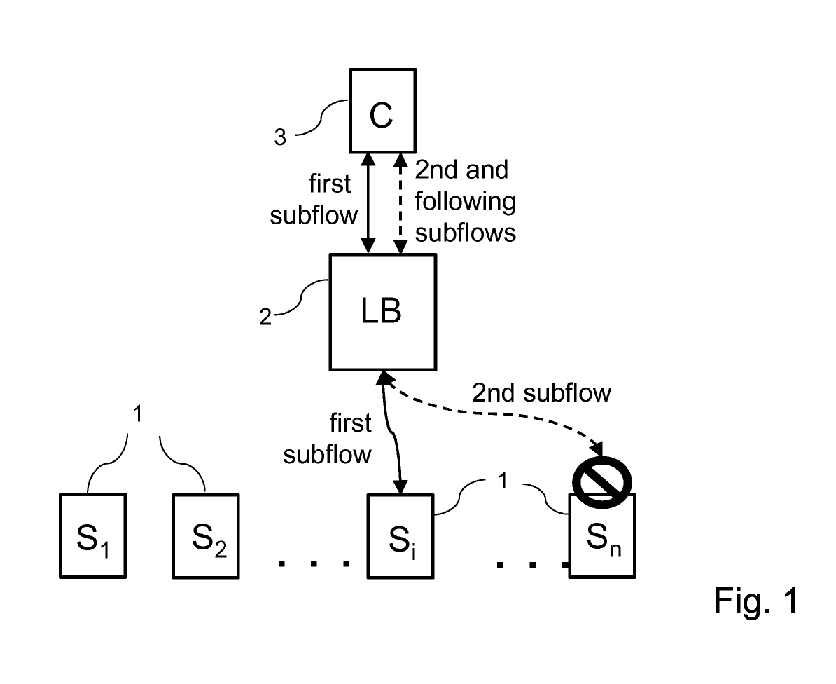

FIG. 1 schematically illustrates a scenario of multipath-unaware load distribution. In this scenario, a number of servers 1 (S1, . . . , Sn), which may be part of a data center, is arranged behind a load balancer 2. The pool of servers 1 is configured to answer requests from clients 3.

As shown in FIG. 1, a multipath-capable client 3 contacts the load balancer 2 and establishes its first subflow to the load balancer 2 (solid line in FIG. 1). Upon MPTCP connection establishment, the load balancer 2 applies a load balancing or distribution algorithm, thereby selecting a suitable server 3 (sever Si in FIG. 1) for processing the client's 3 request within the data center.

When the client 3 tries to open or establish another subflow, i.e. in addition to the first or initial subflow, this request is again handled by the load balancer 2 (dashed line in FIG. 1). However, since the client 3, in accordance with the MPTCP protocol, establishes new subflows by using TCP SYN packets that are sent from a new interface, the load balancer 2 will be confronted with an interface or address not yet known by the load balancer 2. Furthermore, since the MPTCP option used for establishing new subflows (MP_JOIN) is different from the option for initial connection establishment (MP_CAPABLE for the first subflow), the load balancer 2 (which in the illustrated scenario is assumed to not support MPTCP) is not able to determine to which server 1 an associated initial subflow had been forwarded. Therefore, as illustrated in FIG. 1, it might happen that the load balancer 2 selects a server 1 for the second subflow (server Sn in the illustrated scenario) that is different from the server 1 selected for the initial subflow, i.e. server Si. Since a server 1 receiving a SYN packet for a new subflow needs to have received the first subflow of that MPTCP connection as well, in order to be able to accept it and to continue with the handshake, the establishment of the new subflow fails at that moment.

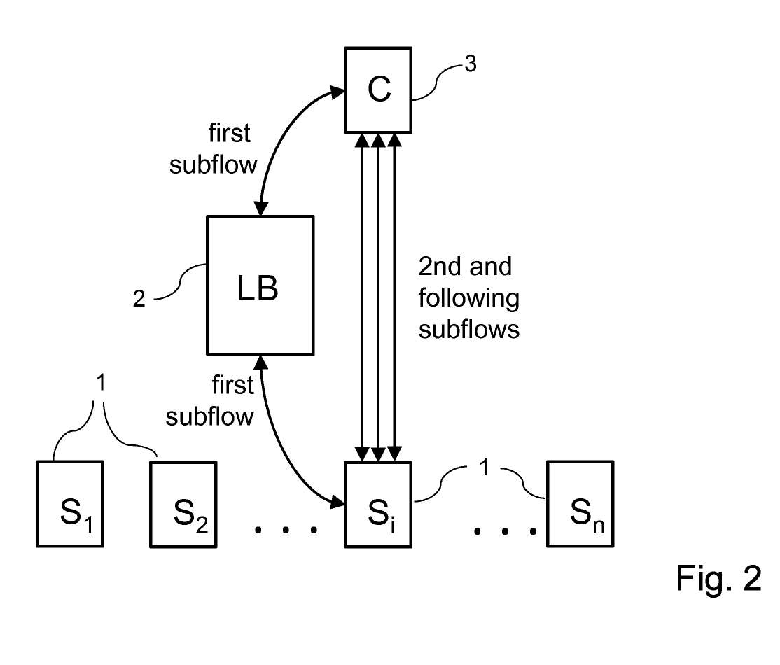

FIG. 2 schematically illustrates a load balancing solution in accordance with a first embodiment of the present invention. The setup is basically the same as in FIG. 1, and like reference numbers denote like components.

Like in FIG. 1, again the multipath-capable client 3 contacts the load balancer 2 and establishes its first subflow to the load balancer 2. Upon MPTCP connection establishment, the load balancer 2 applies a load balancing or distribution algorithm, thereby selecting a suitable server 3 (sever Si in FIG. 2) for processing the client's 3 request within the data center.

The load balancer 2 transparently forwards the initial subflow of the client 3 to server Si selected according to its load balancing algorithm. Furthermore, as from this point on, the load balancer 2 does not accept any further subflows from this client 3. Instead, in accordance with embodiments of the present invention, the server Si negotiates the establishment of further subflows directly with the client 3. To this end, the server Si employs the initial subflow established via the load balancer 2 to announce to the client 3 at least one public interface or address that is directly reachable for the client 3 from the Internet. Once at least one direct client-server subflow is established, traffic is exclusively exchanged directly between the server 1 and the client 3, i.e. not via the load balancer 2.

In the embodiment illustrated in FIG. 2, the traffic that needs to be sent via the load balancer 2 can be minimized by setting the receive window of subflows traversing the load balancer 2 to ‘0’ and/or by using them as backup paths. The load balancer 2 can be configured to decide on the use of these options dynamically.

The illustrated embodiment necessitates that the servers 1 behind the load balancer 2 have public interfaces directly reachable from the Internet. However, in contrast to DNS-based load balancing solutions, these addresses do not need to be published and updated via DNS, but can be managed locally by the load balancer 2, together with the server pool itself. This should speed up connection establishment since DNS entries with a long TTL (Time To Live) can be used for the public interface of the load balancer 2, and thus clients 3 can use cached DNS entries for a service more often. In addition, the interfaces of the server 1 do not need to accept initial subflows, i.e., they do not need to be reachable for any initial client request, greatly reducing security concerns. That is, generally, security concerns from published interfaces of servers can be allayed by not accepting initial subflows at servers and by performing a dynamic, intelligent selection of interfaces to publish.

The load balancer 2 can always fall back to the standard behavior of forwarding all traffic itself if that is to be a deployed option (i.e., implementing a working token-based approach as well). Since all address advertisements from servers 1 to clients 3 pass through the load balancer 2, it can simply replace the advertised interfaces with its own interface(s) or drop them and just accept additional subflows opened by the client 3 to the public interface of the load balancer 2. Thus, all additional subflow setups will also be seen by the load balancer 2 and the traffic over these subflows will also be forwarded by it.

As will be easily appreciated by those skilled in the art, the same method as described in connection with the embodiment of FIG. 2 works not only for a single load balancer 2, but also for multiple layers of load balancers 2 in a data center, since the route taken by the first subflow can be selected freely (for instance, it can be selected using, e.g., consistent hashing), ensuring that all packets of that subflow are routed the same way regardless of a switch to a different load balancer 2. Since all other subflows are routed directly to the servers 1, a switch of load balancers 2, e.g., due to a failure, does not affect these subflows. The method thus avoids the cascaded load balancer 2 issue mentioned in Paasch et al.: “Multipath TCP behind Layer-4 loadbalancers, draft-paasch-mptcp-loadbalancer-00”, MPTCP Working Group, Internet-Draft, Sep. 7, 2015. It also is not affected by the creation of the same tokens on different servers (also raised in the cited document), since with the presented method load balancers do not have to distinguish between these tokens.

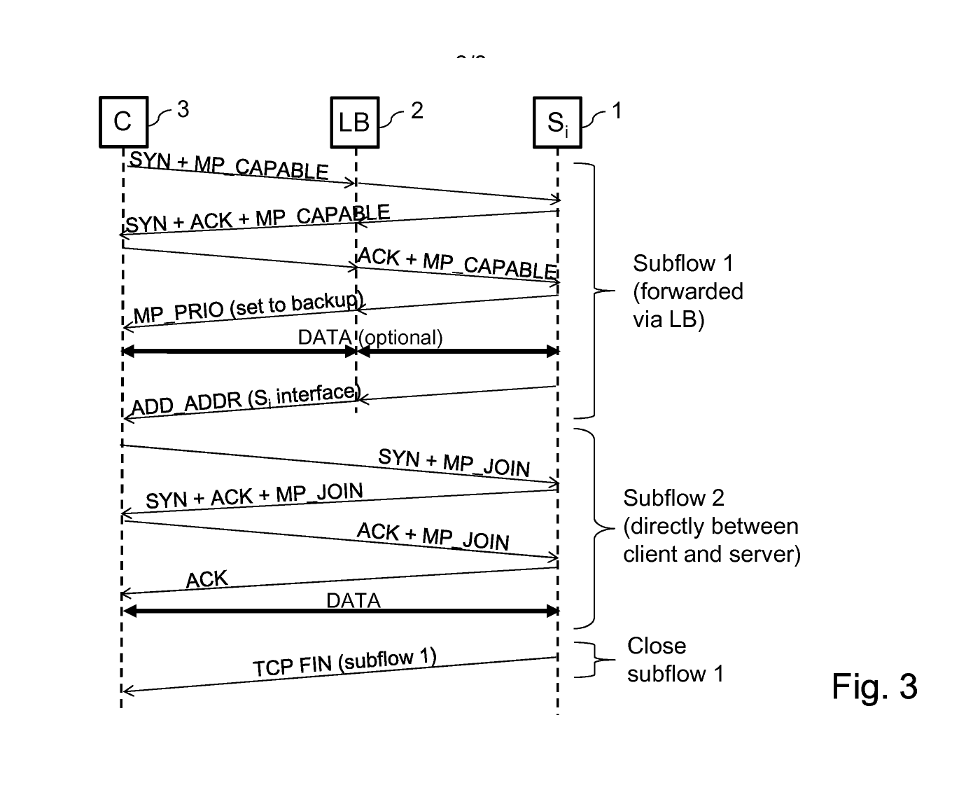

FIG. 3 is a message exchange diagram in accordance with an embodiment of the present invention using the standardized multipath transport protocol, MPTCP. The setup underlying the illustrated message exchange diagram is basically the same as in FIGS. 1 and 2 and, therefore, like reference numbers again denote like components. According to this specific embodiment, the method comprises the following steps:

The method starts with an MPTCP-capable endpoint C, client 3, establishing its first subflow by sending a SYN packet with the MP_CAPABLE option set to the load balancer (LB) 2. The load balancer LB forwards the SYN packet from client C to the server Si selected by its load balancing algorithm.

The server Si conducts the MPTCP handshake with C (via LB), and directly afterwards sends a packet with the MP_PRIO option, signaling to the client C that this first subflow is to be used only as a backup path. This prevents packets from being sent over the subflow once a second subflow is established.

The load balancer LB can set a receive window of 0 in the returning packets from Si during the handshake to prevent data from being sent over this initial subflow, depending on the LB's utilization (i.e., if it cannot forward any data packets due to high load). If the receive window is set to 0, the delay until client C can actually exchange data with Si is increased, while the load on LB is decreased. The load balancer LB also prevents more subflows being established to its public interface by responding to any MP_JOIN SYN packets from this client C with a reset message (i.e. by setting the TCP flag RST), thereby closing the existing MPTCP connection for any further subflows.

Alternatively, instead of only terminating MP_JOIN requests at the load balancer LB as mentioned above, already the generation of these MP_JOIN requests by the client C can be avoided by adding a particular flag, so called flag P, to the MP_CAPABLE SYN/ACK option, as specified in Wei et al.: MPTCP proxy mechanisms—draft-wei-mptcp-proxy-mechanism-0″, Internet-Draft, Jul. 1, 2015. The server Si can indicate to the client C by using this flag P that any MP_JOIN requests are to be sent only to other addresses which the server Si is going to announce soon.

If the receive window was not been set to 0, the load balancer LB forwards any data packets from client C to server Si and in the opposite direction from server Si to client C, rewriting addresses like a standard rewriting load balancer.

After initial sub flow establishment via the load balancer LB, the server Si announces a new address to the client C, using the MPTCP ADD_ADDR option. This address is an interface of the selected server Si. Thus data sent to this address does not pass through the load balancer LB. As an embodiment of a security-conscious address selection, the server Si selects this new address from a pool of addresses assigned to it (e.g., a range of IPv6 addresses), randomly or iteratively, and not reusing this address for other clients during a configurable time interval TRU. In addition, server Si will only accept new subflows to this address for another configurable time interval TA.

The client C opens a new subflow to the announced address, which the selected server Si accepts due to having established the MPTCP connection state parameters with the original SYN packet from client C. The server Si also announces its normal receive window during this handshake, allowing the client C to send data if the receive window was set to 0 before by the load balancer LB.

Client C sends its data segments to server Si exclusively over the new subflow (i.e. not via load balancer LB), since the original flow has been declared as backup. The same applies for data traffic in the opposite direction, i.e. from server Si to client C.

Once the new subflow (or, more precisely, one new subflow in addition to the initial subflow) is established, server Si closes the initial subflow established by the client C, sending a FIN message for this initial subflow. This prevents any more packets reaching the server Si via the load balancer LB.

It should be noted that the server Si is free to announce more addresses or to accept more subflows from client C to exploit multipath transport. Generally, further subflows can be established in the same fashion as the first direct subflow between the client C and the server Si, thereby exploiting the advantages of multipath routing further.

As will be easily appreciated by those skilled in the art, although the embodiment described above is specifically based on the MPTCP protocol, the invention is not restricted to this protocol, but can be applied in connection with any other existing multipath capable solution, as well as with any upcoming future multipath communication protocol having similar characteristics as MPTCP.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for performing load balancing among a plurality of multipath-capable servers being provided behind a load balancer and being configured to process requests from multipath-capable clients, the method comprising:
contacting, by a first multipath-capable client, the load balancer for establishing an initial subflow,
selecting, by the load balancer from the plurality of multipath-capable servers, a selected server by applying a load balancing algorithm,
forwarding, by the load balancer, packets of the initial subflow to the selected server and not accepting any further subflows from the client, and
announcing, by the selected server, at least one public interface to the client via the initial subflow for establishing any subsequent subflows directly between the client and the selected server.

2: The method according to claim 1, wherein forwarding rules for packets of the initial subflow are the only state the load balancer keeps in relation to the client.

3: The method according to claim 1, wherein user data traffic is allowed to be sent from the client only after at least one direct subflow with the selected server has been established, and only via this at least one direct subflow.

4: The method according to claim 1, wherein the load balancer sets a receive window of 0 to the client during the initial subflow establishment.

5: The method according to claim 1, wherein the initial subflow is to be used only as a backup path.

6: The method according to claim 1, wherein the initial subflow is closed once at least one new subflow has been established directly between the selected server and the client.

7: The method according to claim 1, wherein the load balancer terminates any requests for establishing a new subflow to an already existing multipath TCP connection.

8: The method according to claim 1, wherein the load balancer indicates to the client by way of a dedicated flag that any requests for establishing a new subflow associated to an already existing multipath TCP connection are to be sent to other addresses to be announced by the selected server.

9: The method according to claim 1, wherein the selected server ignores and/or rejects subflows that do not match any existing initial subflows that have passed via the load balancer.

10: The method according to claim 1, wherein the announced public interfaces of the selected server are selected taking into account security considerations.

11: The method according to claim 1, wherein the selected server varies the announced public interfaces over time.

12: The method according to claim 1, wherein the selected server accepts new subflows to a particular announced public interface only within a specific time period after its announcement.

13: A system, comprising:
a load balancer, and
a plurality of multipath-capable servers provided behind the load balancer and configured to process requests from multipath-capable clients,
wherein the load balancer is configured to:
receive a request for establishing an initial subflow from a client, select, from the plurality of multipath-capable servers by applying a load balancing algorithm, a selected server for serving the request, and
forward packets of the initial subflow to the selected server and to not accept any further subflows from the client,
wherein the selected server is configured to announce at least one public interface to the client via the initial subflow for establishing any subsequent subflows directly between the client and the selected server.

14. (canceled)

15. (canceled)
